(19) United States
(12) Patent Application Publication
(10) Pub. No.: US 2012/0324165 A1
(43) Pub. Date: Dec. 20, 2012

(54) MEMORY CONTROL DEVICE AND MEMORY CONTROL METHOD

(75) Inventors: Norifumi Tsuboi, Fussa-shi (JP); Kenji Yoshida, Akishima-shi (JP)

(73) Assignee: KABUSHIKI KAISHA TOSHIBA, Tokyo (JP)

(21) Appl. No.: 13/404,969

(22) Filed: Feb. 24, 2012

(30) Foreign Application Priority Data
Jun. 20, 2011 (JP) 2011-136785

(51) Int. Cl. G06F 12/08

(52) U.S. Cl. 711/118; 711/E12.017

(57) ABSTRACT

According to one embodiment, a memory control device includes: a buffer memory; a cache memory performing caching for the buffer memory on a unit-data-by-unit-data basis; and an adding module adding ByteECC data to the unit data.

### CROSS REFERENCE TO RELATED APPLICATION(S)

The application is based upon and claims the benefit of priority from Japanese Patent Application No. 2011-136785 filed on Jun. 20, 2011, the entire contents of which are incorporated herein by reference.

### BACKGROUND

1. Field

The present invention relates to a memory control device and a memory control method.

2. Description of the Related Art

An ECC (error checking and correcting) code for protection against DRAM data corruption needs to be added to data of each access unit. Whereas adding an ECC code to data of each small access unit is disadvantageous in that a large storage area is required, it is advantageous in that small-unit access is fast.

On the other hand, adding an ECC code to data of each large access unit is disadvantageous in that all data needs to be read and subjected to ECC checks even in using part of the data because the data can be accessed only in large units. Furthermore, writing needs to be performed after all data is read out for ECC re-calculation, resulting in slow access. However, it is advantageous in that the storage area can be saved because the total size of ECC codes is small.

One method for solving the above problems is known in which an ECC code is added to data of large access unit to suppress consumption of the capacity of a nonvolatile storage medium in storing data in the storage medium. When the data is used after being copied to a DRAM, an ECC code is added to data of small access unit. However, in this method, time and processing are required to switch the ECC method.

That is, whereas a technique for changing the ECC method automatically in memory access is desired, no means for satisfying that desire is available.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a block diagram showing a typical configuration of an electronic apparatus that is equipped with a magnetic disk device according to an embodiment;

FIGS. 2A and 2B are conceptual charts illustrating ByteECC addition which is performed in the embodiment;

FIGS. 3A and 3B are flowcharts of processes which are mainly executed by a CPU in the embodiment;

FIG. 4 illustrates an example of cache-miss reading that is performed before ByteECC addition according to the embodiment;

FIG. 5 illustrates an example of ByteECC addition by write-back according to the embodiment; and

FIG. 6 illustrates an example of cache-miss reading that is performed after ByteECC addition according to the embodiment.

### DETAILED DESCRIPTION

According to one embodiment, a memory control device includes: a buffer memory; a cache memory performing caching for the buffer memory on a unit-data-by-unit-data basis; and an adding module adding ByteECC data to the unit data.

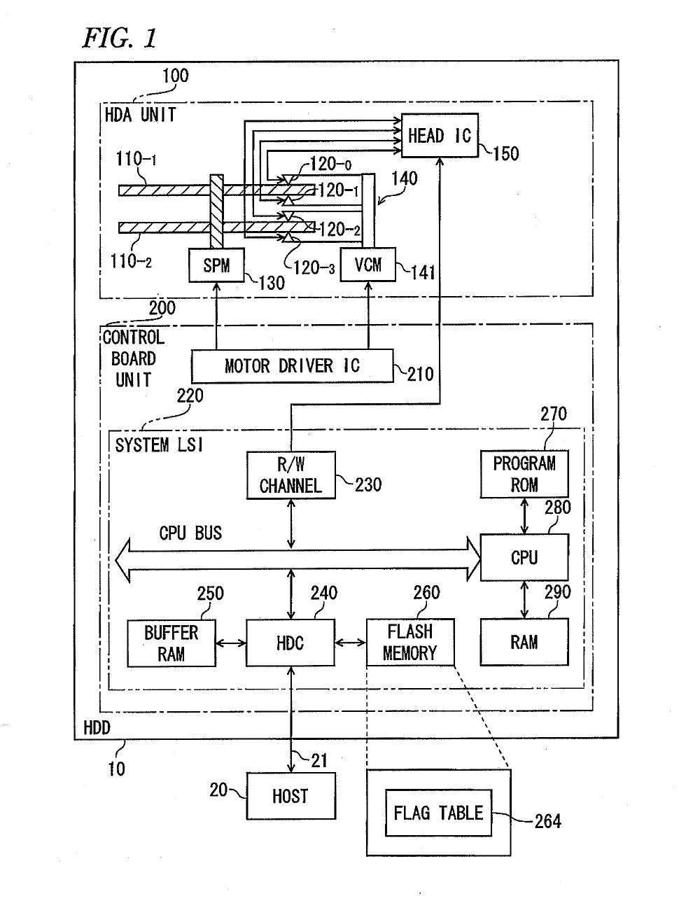

An embodiment will be hereinafter described with reference to FIGS. 1-6.

FIG. 1 is a block diagram showing a typical configuration of an electronic apparatus that is equipped with a magnetic disk device according to the embodiment. As shown in FIG. 1, the electronic apparatus is equipped with the magnetic disk device (HDD) 10 and a host (host system) 20. For example, the electronic apparatus is a personal computer, a video camera, a music player, a portable terminal, or a cell phone. The host 20 uses the HDD 10 as a storage device for itself.

The HDD 10 is equipped with a head disk assembly unit (HDA unit) 100 and a control board unit 200. The HDA unit 100 is equipped with two disks (magnetic disks) 110-1 and 110-2, for example, a spindle motor (SPM) 130, an actuator 140, and a head IC 150.

Each of the disks 110-1 and 110-2 has two recording surfaces, that is, a top surface and a bottom surface. The disks 110-1 and 110-2 are rotated at high speed by the SPM 130. The disk 110-i (i=1, 2) employs a known recording format called CDR (constant density recording). Therefore, each recording surface of the disk 110-i is managed being divided into plural zones in the radial direction. That is, each recording surface of the disk 110-i is provided with plural zones.

The actuator 140 is provided with heads (magnetic heads) 120-0 and 120-1 at the tips of head arms that are disposed so as to correspond to the respective recording surfaces of the disk 110-1. The actuator 140 is also provided with heads 120-3 and 120-4 at the tips of head arms that are disposed so as to correspond to the respective recording surfaces of the disk 110-2. The heads 120-0 and 120-1 are used for writing and reading data to and from the disk 110-1, and the heads 120-3 and 120-4 are used for writing and reading data to and from the disk 110-2.

The actuator 140 is provided with a voice coil motor (VCM) 141. The actuator 140 is driven by the VCM 141 and moves the heads 120-0 to 120-3 in the radial directions of the disks 110-1 and 110-2.

The SPM 130 and VCM 141 are driven by drive currents (SPM current and VCM current) supplied from a motor driver IC 210 (described later).

The head IC 150 amplifies a signal (read signal) that is read out by the head 120-j (j=0, 1, 2, 3). Furthermore, the head IC 150 converts write data that is transferred from a read/write channel 230 (described later) into a write current and outputs the write current to the head 120-j.

The control board unit 200 is equipped with two LSIs, that is, the motor driver IC 210 and a system LSI 220. The motor driver IC 210 drives the SPM 130 so that it rotates at a constant speed. Furthermore, the motor driver IC 210 drives the actuator 140 by supplying the VCM 141 with a current (VCM current) having a value corresponding to a VCM manipulation amount that is specified by a CPU 280.

The system LSI 220 is an SOC (system on chip) LSI in which the read/write channel (R/W channel) 230, a disk controller (HDC) 240, a buffer RAM 250, a flash memory 260, a program ROM 270, the CPU 280, and a RAM 290 are integrated together. A line cache area (described later) can be realized on, for example, a cache memory formed in the CPU 280 or the RAM 290.

The R/W channel 230 is a signal processing device which performs signal processing relating to reading and writing. The R/W channel 230 converts a read signal into digital data and decodes the digital data into read data. Furthermore, the R/W channel 230 extracts, from the digital data, servo data that is necessary for positioning of the head 120-j. Still further, the R/W channel 230 encodes write data.

The HDC 240 is connected to the host 20 via a host interface 21. The HDC 240 receives a command (write command, read command, or the like) that is transferred from the host 20. The HDC 240 controls data transfer between the host 20 and the HDC 240. The HDC 240 also controls data transfer between itself and the disk 110-i (i=1, 2) that is performed via the R/W channel 230.

The buffer RAM 250 is used for temporarily storing data to be written to the disk 110-i or data that has been read from the disk 110-i via the head IC 150 and the R/W channel 230.

The flash memory 260 is a rewritable nonvolatile memory. The flash memory 260 is used for temporarily storing, for example, fractional sector data of a write command that is received from the host 20.

The program ROM 270 is stored with control programs (firmware programs) in advance. The control programs may be stored in part of the storage area of the flash memory 260.

The CPU 280 functions as a main controller of the HDD 10. The CPU 280 controls at least part of the other components of the HDD 10 according to the control programs stored in the program ROM 270. Part of the storage area of the RAM 290 is used as a work area of the CPU 280. Part of data stored in the flash memory 260 is loaded into the work area of the RAM 290 when the HDD 10 is powered on.

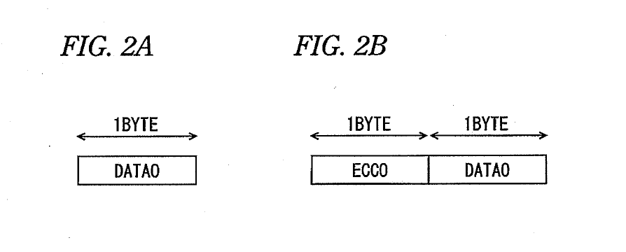

As shown in FIGS. 2A and 2B, ByteECC addition which is performed commonly is adding 5-bit ECC data to 1-byte data (in the embodiment, for the sake of convenience, 5-bit data is regarded as 1-byte data; 5-bit data enables 1-bit error correction and 2-bit error detection). More specifically, data of 2 bytes in total is produced by adding ECC data ECC0 (see FIG. 2B) to original data DATA0 (see FIG. 2A).

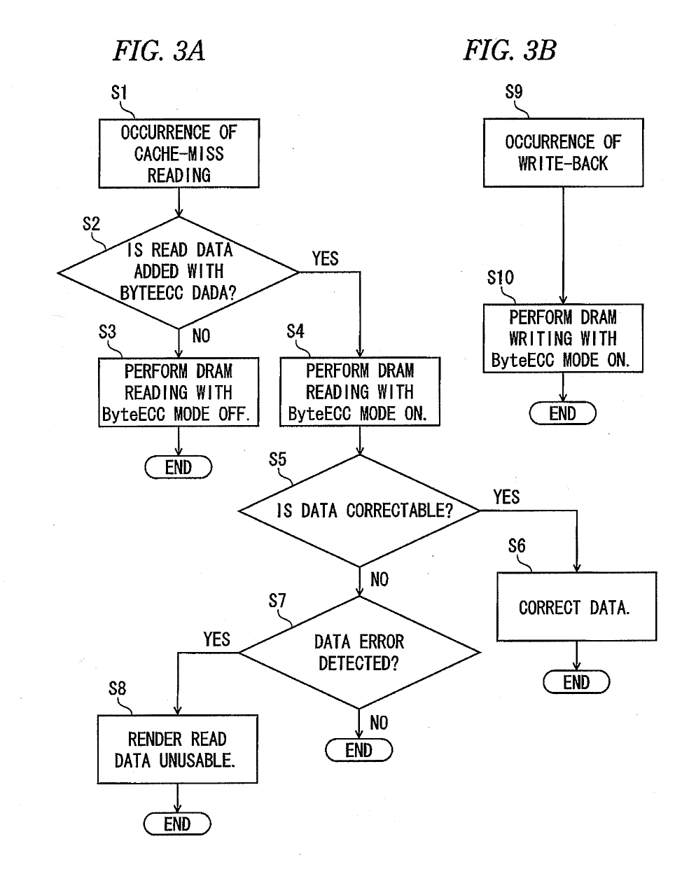

In an actual hardware operation, the HDC 240 or the CPU 280 in which a ByteECC addition flag for a DRAM address is provided in its internal circuit judges whether or not ByteECC data have been added to read data that is supplied from a DRAM at the occurrence of cache-miss reading (see FIG. 3A). All data that is read from the DRAM is cached in reading data that is not added with ByteECC data. A mechanism is provided which caches user data that is read from the DRAM in reading data that is added with ByteECC data (ByteECC data are not cached).

A process which is mainly executed by the HDC 240 or the CPU 280 will be described below in detail with reference to a flowchart of FIG. 3A.

Step S1: Occurrence of cache-miss reading is recognized.

Step S2: It is judged whether or not data that is read from the DRAM is added with ByteECC data.

Step S3: If the judgment result of step S2 is negative, DRAM reading is performed with the ByteECC mode off.

Step S4: If the judgment result of step S2 is affirmative, DRAM reading is performed with the ByteECC mode on.

Step S5: It is judged whether the data is correctable or not.

Step S6: If the judgment result of step S5 is affirmative, the data is corrected.

Step S7: If the judgment result of step S5 is negative, it is judged whether or not a data error has already been detected.

Step S8: If the judgment result of step S6 is affirmative, the read data is rendered unusable.

FIG. 3B is a flowchart of a process which is mainly executed by the CPU 280. If right-back is to be performed (step S9), DRAM writing is performed after adding 1-byte ByteECC data to each 1-byte user data at a 1-byte higher address, for example (step S10).

By generating ECC data for each unit data containing ByteECC data, ECC data protection can be performed for DRAM transfer in a device that is not provided with the above function excluding a line cache.

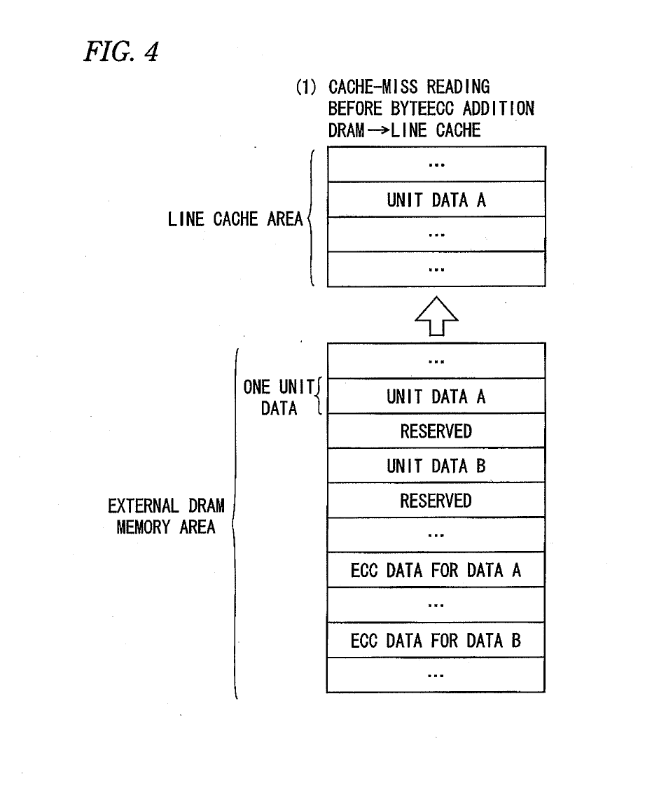

However, to implement the above function, a free area (denoted by “reserved” in FIG. 4; e.g., 512 bytes) having the same size as an ECC addition subject area needs to exist in a DRAM. FIG. 4 illustrates an example of cache-miss reading that is performed before ByteECC addition according to the embodiment. ECC data for, for example, unit data A also exists in an external DRAM memory area (buffer RAM 250). The same is true of other unit data such as unit data B.

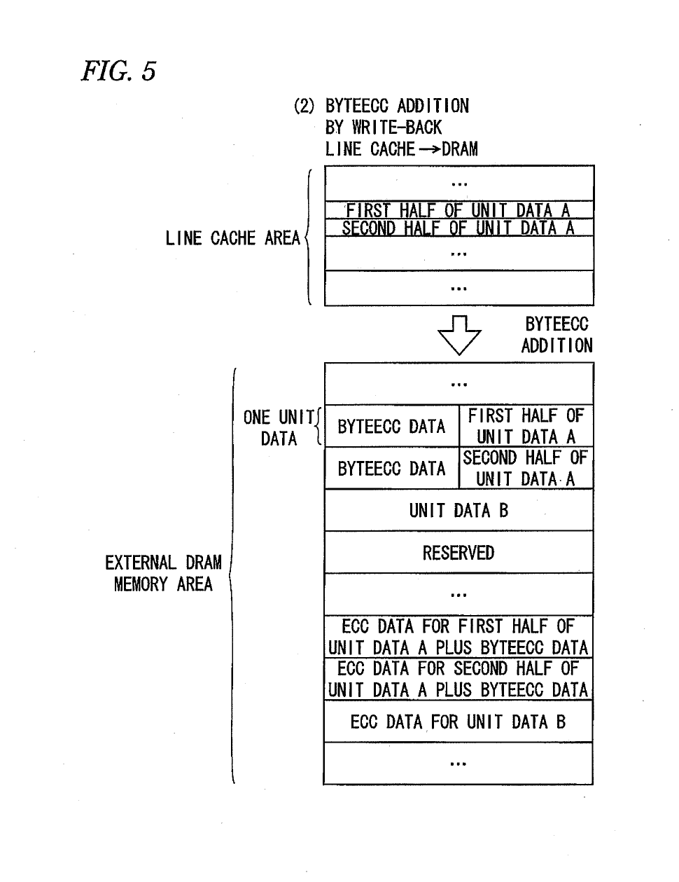

FIG. 5 illustrates an example of ByteECC addition by write-back according to the embodiment. With the data positions shown in FIG. 4, as indicated by an arrow, write-back is performed while ByteECC data are added. In practice, it is preferable that write-back be performed as a collection of 2-byte unit data (see FIG. 2). For example, ECC data for unit data A is written with such a form change that it is divided into ECC data for a first half of unit data A plus ByteECC data and ECC data for a second half of unit data A plus ByteECC data.

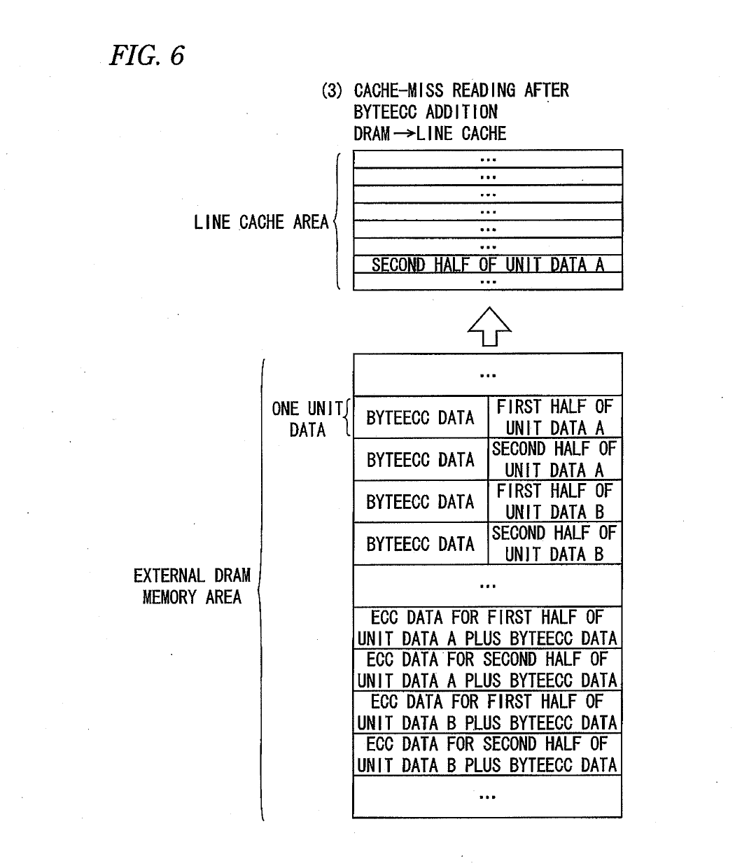

FIG. 6 illustrates an example of cache-miss reading that is performed after ByteECC addition according to the embodiment. Whereas data of 512 bytes are read from the external DRAM memory area, data of 256 bytes excluding ByteECC data are cached.

An ECC code for protection against DRAM data corruption needs to be added to data of each access unit. Whereas adding an ECC code to data of each small access unit is disadvantageous in that a large storage area is required, it is advantageous in that small-unit access is fast.

On the other hand, adding an ECC code to data of each large access unit is disadvantageous in that all data needs to be read and subjected to ECC checks even in using part of the data because the data can be accessed only in large units. Furthermore, writing needs to be performed after all data is read out for ECC re-calculation, resulting in slow access. However, it is advantageous in that the storage area can be saved because the total size of ECC codes is small.

One method for solving the above problems is known in which an ECC code is added to data of each large access unit to suppress consumption of the capacity of a nonvolatile storage medium in storing data in the storage medium. When the data is used after being copied to a DRAM, an ECC code is added to data of each small access unit. However, in this method, time and processing are required to switch the ECC method.

In contrast, in the method according to the embodiment, since hardware automatically changes the ECC method for a necessary amount of data when a CPU access a DRAM, the CPU need not care about changing of the ECC method. Furthermore, since the ECC method is changed in a divisional manner when necessary, data can be used immediately after being copied to a DRAM.

For example, the HDC 240 may manage flags each indicating whether or not ByteECC data is added to corresponding unit data stored in the buffer RAM 150, using a flag table 264 stored in the flash memory 260.

In what is called a line cache method with an ECC code automatic addition function according to the embodiment, since hardware automatically changes the ECC method for a necessary amount of data when a CPU access a DRAM, the CPU need not care about changing of the ECC method. Furthermore, since the ECC method is changed in a divisional manner when necessary, data can be used immediately after being copied to a DRAM.

The embodiment provides the following line cache function. When data is read from a DRAM for the first time (see FIG. 4), the data is read without ByteECC data. When the data is written back to the DRAM (see FIG. 5), ByteECC are added for protection of the data. When the data is read from the DRAM second time or later (see FIG. 6), error detection and correction is performed automatically for the data using the ByteECC data.

The invention is not limited to the above embodiment, and can be practiced so as to be modified in various manners without departing from the spirit and scope of the invention. For example, the caching subject is not limited to user data and may be firmware code etc. The invention may be applied to a case of transferring firmware code on what is called a media firmdisk to a RAM or a rewritable ROM so as to be developed there.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A memory control device comprising:
a buffer memory;
a cache memory configured to perform caching for the buffer memory on a unit-data-by-unit-data basis; and
an adding module configured to add ByteECC data to the unit data.

2. The memory control device according to claim 1, wherein the adding module is configured to add ByteECC data to cached unit data when the cached unit data are written back to the buffer memory.

3. The memory control device according to claim 1, further comprising a flag managing module configured to manage whether the unit data stored in the buffer memory is added with ByteECC data.

4. The memory control device according to claim 1, further comprising an error detecting and correcting module configured to perform error detection and correction using the added ByteECC data.

5. A memory control method of a memory control device comprising a buffer memory, the method comprising:
performing caching for the buffer memory on a unit-data-by-unit-data basis; and
adding ByteECC data to the unit data.

6. The memory control method according to claim 5, wherein when cached unit data are written back to the buffer memory, ByteECC data is added to the cached unit data.

7. The memory control method according to claim 5, further comprising:
managing whether the unit data stored in the buffer memory is added with ByteECC data.

8. The memory control method according to claim 5, further comprising:
performing error detection and correction using the added ByteECC data.
